(19) United States
(12) Patent Application Publication
(10) Pub. No.: US 2026/0034560 A1
(43) Pub. Date: Feb. 5, 2026

(54) SEPARATOR PARALLEL COATING DEVICE

(71) Applicant: KATOP Automation Co., Ltd., Shenzhen (CN)

(72) Inventors: Gaowen ZHU, Shenzhen (CN); Baojian LEI, Shenzhen (CN); Shenghui YAN, Shenzhen (CN)

(73) Assignee: KATOP Automation Co., Ltd., Shenzhen (CN)

(21) Appl. No.: 19/290,669

(22) Filed: Aug. 5, 2025

(30) Foreign Application Priority Data
Aug. 5, 2024 (CN) 202421881722.8

(51) Int. Cl. B05C 13/00; B05C 9/04; B05C 9/14; H01M 50/403

(52) U.S. Cl. CPC B05C 13/00; B05C 9/04; B05C 9/14; H01M 50/403

(57) ABSTRACT

A separator parallel coating device includes a first coating apparatus, a second coating apparatus, and a reversing apparatus. The first coating apparatus and the second coating apparatus are arranged side by side in a front-rear manner, the first coating apparatus and the second coating apparatus each include an unwinding mechanism, an A-side coating mechanism, a first oven, a B-side coating mechanism, a second oven, a discharging traction mechanism, and a winding mechanism, the winding mechanism, the unwinding mechanism, the A-side coating mechanism, the first oven, and the B-side coating mechanism are sequentially arranged at intervals from left to right, the discharging traction mechanism is located above the unwinding mechanism and the A-side coating mechanism, the second oven is located above the first oven, and the reversing apparatus includes a first reversing mechanism, a second reversing mechanism, and a transition mechanism.

### CROSS-REFERENCE TO RELATED APPLICATIONS

This application claims priority to Chinese Patent Application No. 202421881722.8, filed on Aug. 5, 2024, the content of which is incorporated herein by reference in its entirety.

### TECHNICAL FIELD

The present application relates to the technical field of coating, specifically to a separator parallel coating device.

### BACKGROUND

During production of lithium battery separators 100, the separator 100 usually needs to be coated with materials such as aluminum oxide, boehmite, and vinylidene fluoride to improve the thermal shrinkage performance of the separator 100 and its adhesion to the positive and negative active materials. Currently, the existing double-sided separator coating machine generally includes an unwinding mechanism for unwinding the separator 100, a first coating mechanism for coating the A side, such as the front side, of the separator 100 to form a coating 101, a first oven for heating and drying the coating 101 on the A side of the separator 100, a second coating mechanism for coating the B side, such as the back side, of the separator 100 to form a coating 101, a second oven for heating and drying the coating 101 on the B side of the separator 100, and a winding mechanism for winding the separator 100. This kind of double-sided separator coating machine can only perform double coating on the separator 100 to form one coating 101 on each of the A side and the B side of the separator 100, as shown in FIG. 1. However, when the separator 100 needs to be coated for, for example, four times to form two coatings 101 on each of the A side and the B side of the separator 100, two independent coating machines are needed, as shown in FIG. 2, so that production personnel and material transfer procedures need to be added, the production efficiency is reduced, and the production cost is increased.

### SUMMARY

To overcome the deficiencies in the prior art, the present application provides a separator parallel coating device, which can reduce the number of production personnel and material transfer procedures, greatly improve the production efficiency, and lower the production cost.

A technical solution adopted by the present application to solve the technical problems is as follows.

A separator parallel coating device includes a first coating apparatus, a second coating apparatus, and a reversing apparatus, where the first coating apparatus and the second coating apparatus are arranged side by side in a front-rear manner, the first coating apparatus and the second coating apparatus each include an unwinding mechanism, an A-side coating mechanism, a first oven, a B-side coating mechanism, a second oven, a discharging traction mechanism, and a winding mechanism, the winding mechanism, the unwinding mechanism, the A-side coating mechanism, the first oven, and the B-side coating mechanism are sequentially arranged at intervals from left to right, the discharging traction mechanism is located above the unwinding mechanism and the A-side coating mechanism, the second oven is located above the first oven, the reversing apparatus includes a first reversing mechanism, a second reversing mechanism, and a transition mechanism, the first reversing mechanism is disposed in the discharging traction mechanism of the first coating apparatus, the second reversing mechanism is disposed in the discharging traction mechanism of the second coating apparatus, the transition mechanism is located between the first reversing mechanism and the second reversing mechanism, and the transition mechanism has one end disposed in the discharging traction mechanism of the first coating apparatus, and the other end disposed in the discharging traction mechanism of the second coating apparatus.

As a preferred technical solution, the first coating apparatus and the second coating apparatus each include a support platform, where the unwinding mechanism, the A-side coating mechanism, the first oven, and the B-side coating mechanism are all located in the support platform, both the discharging traction mechanism and the second oven are disposed at a top end of the support platform, the discharging traction mechanism includes a discharging traction platform disposed at the top end of the support platform, a plurality of driving traction rollers are disposed on the discharging traction platform, and the plurality of driving traction rollers are sequentially arranged at intervals from right to left.

As a preferred technical solution, the first reversing mechanism and the second reversing mechanism are symmetrically arranged in a front-rear manner, the first reversing mechanism and the second reversing mechanism each include a reversing frame and an air floating roller, the reversing frame of the first reversing mechanism is disposed in the discharging traction platform of the first coating apparatus, the reversing frame of the second reversing mechanism is disposed in the discharging traction platform of the second coating apparatus, the air floating roller has a hollow structure, two sealing plates are disposed at one end and the other end of the air floating roller respectively, the two sealing plates are disposed at a top end of the reversing frame, one of the sealing plates is provided with a connector, the connector communicates with an interior of the air floating roller and is connected to an air blower, an outer peripheral surface of the air floating roller is provided with an air hole area where a plurality of air outlet holes are evenly distributed, and the plurality of air outlet holes all communicate with the interior of the air floating roller.

As a preferred technical solution, the reversing frame has a first corner and a second corner arranged diagonally, and a third corner and a fourth corner arranged diagonally, both the first corner and the third corner are close to the transition mechanism, the third corner is located between the first corner and the second oven, the air floating roller has one end close to the first corner and located between the first corner and the third corner, and the other end close to the second corner and located between the fourth corner and the second corner, and the air hole area faces the fourth corner of the reversing frame.

As a preferred technical solution, the transition mechanism includes a transition platform, where the transition platform has one end disposed in the discharging traction platform of the first coating apparatus, and the other end disposed in the discharging traction platform of the second coating apparatus, the transition platform is located between and below the reversing frame of the first reversing mechanism and the reversing frame of the second reversing mechanism, a plurality of transition pass rollers are disposed on the transition platform, and the plurality of transition pass rollers are sequentially arranged at intervals from front to rear.

As a preferred technical solution, a flattening frame is disposed on one side of the reversing frame close to the transition platform, the flattening frame is located above the transition platform, and a flattening roller is disposed on the flattening frame.

As a preferred technical solution, a pass roller frame is disposed on one side of the reversing frame close to the second oven, and a reversing pass roller is disposed on the pass roller frame.

As a preferred technical solution, the A-side coating mechanism and the B-side coating mechanism of the first coating apparatus each include a coating frame, and a gravure roller and two approach rollers disposed on the coating frame, where the two approach rollers are arranged side by side in an upper-lower manner, and the gravure roller is located on one side of the two approach rollers and is opposite to the two approach rollers.

As a preferred technical solution, the A-side coating mechanism and the B-side coating mechanism of the second coating apparatus each include a spraying frame, a spraying machine, and an upper spraying pass roller and a lower spraying pass roller disposed on the spraying frame, where the upper spraying pass roller and the lower spraying pass roller are arranged side by side in an upper-lower manner, and the spraying machine is disposed on one side of the upper spraying pass roller and the lower spraying pass roller, and is opposite to the upper spraying pass roller and the lower spraying pass roller.

As a preferred technical solution, the first coating apparatus and the second coating apparatus each include a preheating oven disposed between the unwinding mechanism and the A-side coating mechanism, and a winding traction mechanism disposed between the winding mechanism and the unwinding mechanism, where both the preheating oven and the winding traction mechanism are located below the discharging traction mechanism and in the support platform.

The present application has the following beneficial effects. According to the present application, the first coating apparatus, the second coating apparatus, and the reversing apparatus are disposed, where the first coating apparatus and the second coating apparatus each include the unwinding mechanism, the A-side coating mechanism, the first oven, the B-side coating mechanism, the second oven, the discharging traction mechanism, and the winding mechanism, and the reversing apparatus includes the first reversing mechanism, the second reversing mechanism, and the transition mechanism. The A side and the B side of a separator can be coated by the first coating apparatus to form a first coating and a second coating of the separator. The separator can be guided from the first coating apparatus to the second coating apparatus by the reversing apparatus, so that the first coating and the second coating of the separator can be coated by the second coating apparatus to form a third coating and a fourth coating of the separator. In this way, the separator can be coated for four times. Compared with the prior art, the number of production personnel and material transfer procedures can be reduced, the production efficiency is greatly improved, and the production cost is lowered.

### BRIEF DESCRIPTION OF THE DRAWINGS

The present application is further described below in conjunction with the accompanying drawings and embodiments. In the drawings:

FIG. 1 is a schematic diagram of a structure in which a coating is formed on each of an A side and a B side of a separator;

FIG. 2 is a schematic diagram of a structure in which two coatings are formed on each of an A side and a B side of a separator;

FIG. 3 is a schematic top view of a separator parallel coating device provided by an embodiment of the present application;

FIG. 4 is a schematic sectional view of a first coating apparatus, a first reversing mechanism, a second coating apparatus, and a second reversing mechanism of the separator parallel coating device shown in FIG. 3;

FIG. 5 is a schematic sectional view of an unwinding mechanism, a preheating oven, and an A-side coating mechanism of the first coating apparatus shown in FIG. 4;

FIG. 6 is a schematic sectional view of a B-side coating mechanism of the first coating apparatus shown in FIG. 4;

FIG. 7 is a schematic sectional view of the first reversing mechanism, and a discharging traction mechanism, a winding traction mechanism, and a support platform of the first coating apparatus shown in FIG. 4;

FIG. 8 is a schematic sectional view of a winding mechanism of the first coating apparatus shown in FIG. 4;

FIG. 9 is a schematic sectional view of an A-side coating mechanism of the second coating apparatus shown in FIG. 4;

FIG. 10 is a schematic sectional view of a B-side coating mechanism of the second coating apparatus shown in FIG. 4;

FIG. 11 is a schematic sectional view of the second reversing mechanism, and a discharging traction mechanism, a winding traction mechanism, and a support platform of the second coating apparatus shown in FIG. 4;

FIG. 12 is a schematic structural diagram of a reversing apparatus of the separator parallel coating device shown in FIG. 3;

FIG. 13 is a schematic structural diagram of a second reversing mechanism of the reversing apparatus shown in FIG. 12; and

FIG. 14 is a schematic structural diagram of a transition mechanism of the reversing apparatus shown in FIG. 12.

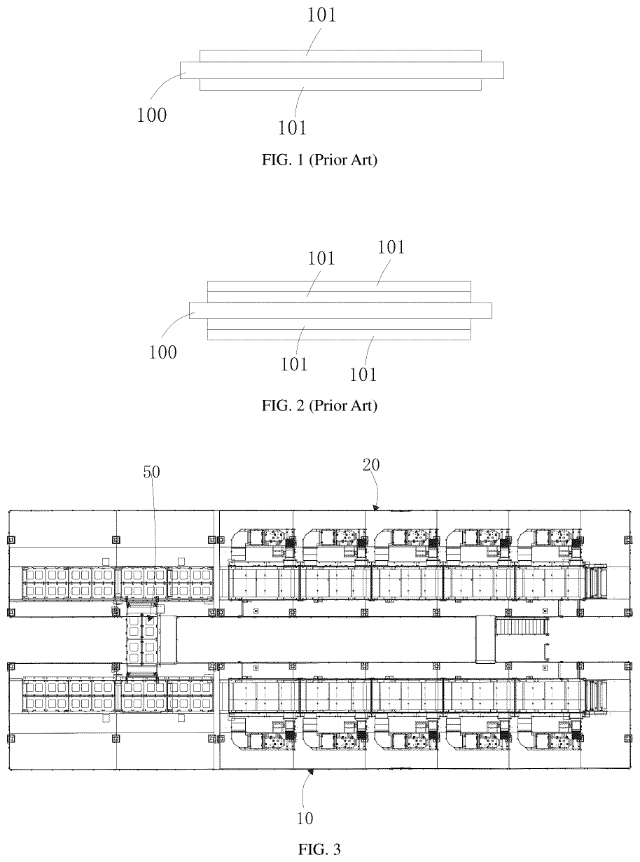

### DETAILED DESCRIPTION OF THE EMBODIMENTS

The concept, specific structure, and technical effects of the present application will be clearly and completely described below in conjunction with the embodiments and accompanying drawings to fully understand the objective, features, and effects of the present application. Apparently, the described embodiments are merely some rather than all of the embodiments of the present application, and all other embodiments obtained by those skilled in the art based on the embodiments of the present application without creative efforts fall within the scope of protection of the present application. In addition, all the coupling/connection relationships referred to in the patent do not only mean that the components are directly connected, but also mean that a better coupling structure can be formed by adding or reducing coupling accessories according to specific implementation situations. The various technical features in the present application can be interactively combined without conflicting with each other.

Referring to FIG. 3, a separator parallel coating device provided by an embodiment of the present application includes a first coating apparatus 10, a second coating apparatus 20, and a reversing apparatus 50. The first coating apparatus 10 and the second coating apparatus 20 are arranged side by side in a front-rear manner.

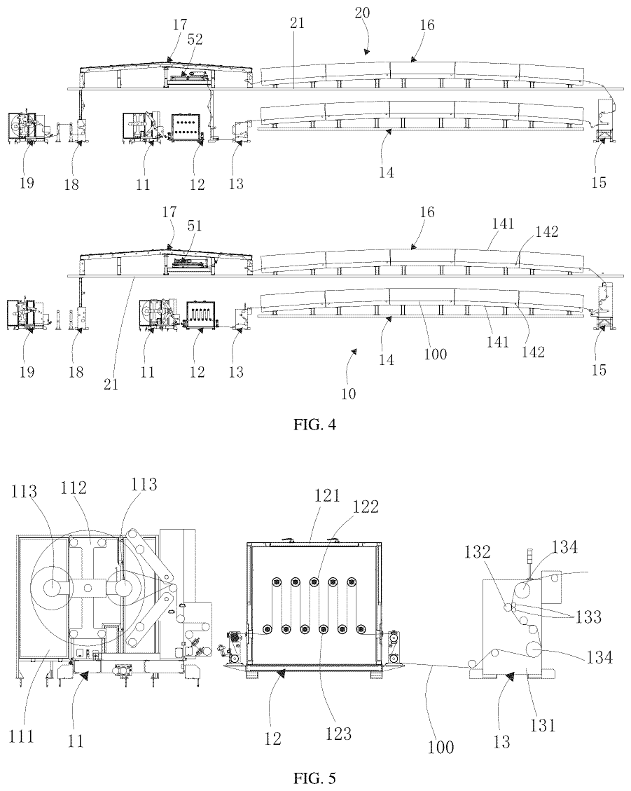

As shown in FIG. 4, the first coating apparatus 10 includes an unwinding mechanism 11, a preheating oven 12, an A-side coating mechanism 13, a first oven 14, a B-side coating mechanism 15, a second oven 16, a discharging traction mechanism 17, a winding traction mechanism 18, a winding mechanism 19, and a support platform 21. The winding mechanism 19, the winding traction mechanism 18, the unwinding mechanism 11, the preheating oven 12, the A-side coating mechanism 13, the first oven 14, and the B-side coating mechanism 15 are sequentially arranged at intervals left to right. The winding traction mechanism 18, the unwinding mechanism 11, the preheating oven 12, the A-side coating mechanism 13, the first oven 14, and the B-side coating mechanism 15 are all located in the support platform 21. Both the discharging traction mechanism 17 and the second oven 16 are disposed at a top end of the support platform 21. The discharging traction mechanism 17 is located above the winding traction mechanism 18, the unwinding mechanism 11, the preheating oven 12, and the A-side coating mechanism 13, the discharging traction mechanism 17 is located on a left side of the second oven 16, and the second oven 16 is located above the first oven 14.

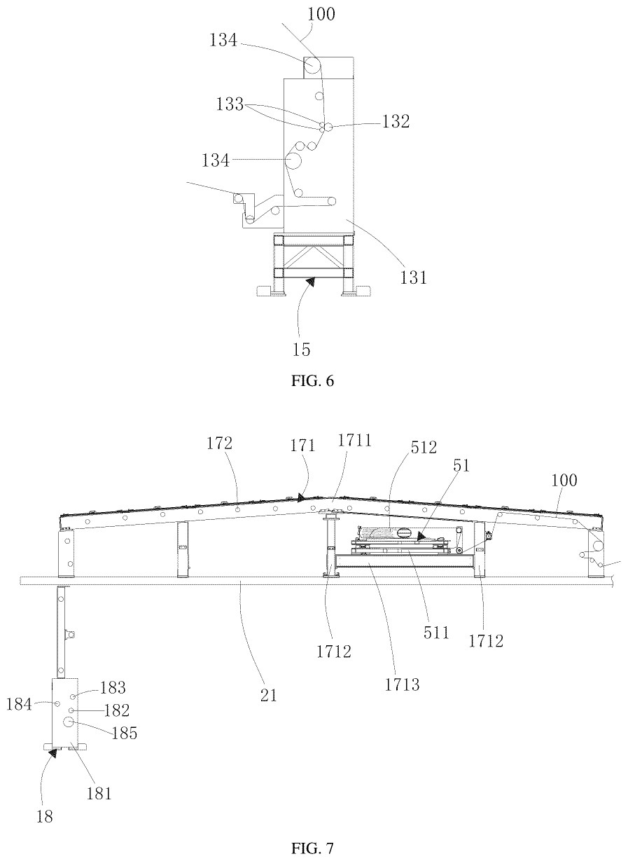

As shown in FIG. 4, FIG. 5, and FIG. 6, the unwinding mechanism 11 is configured to unwind a separator 100. The unwinding mechanism 11 includes an unwinding frame 111, an unwinding turret 112 disposed on the unwinding frame 111, and two unwinding shafts 113 disposed on the unwinding turret 112. The two unwinding shafts 113 are symmetric about a center of the unwinding turret 112. The unwinding turret 112 is configured to drive the two unwinding shafts 113 to rotate about the center of the unwinding turret 112 for mutual switching of workstations, so as to achieve roll changing. The unwinding shafts 113 are configured to unwind the separator 100. In practical applications, for the convenience of description, the two unwinding shafts 113 are named a first unwinding shaft 113 and a second unwinding shaft 113 respectively. For example, first, a first reel and a second reel that are wound with the separator 100 are mounted on the first unwinding shaft 113 and the second unwinding shaft 113 respectively. Then, the separator 100 on the first reel is unwound through the first unwinding shaft 113. When the separator 100 on the first reel is almost completely unwound, the first unwinding shaft 113 and the second unwinding shaft 113 are driven by the unwinding turret 112 to rotate about the center of the unwinding turret 112 for mutual switching of workstations. Next, the moving separator 100 is pressed tightly against an adhesive application position of the separator 100 on the second reel and then cut. In this way, tape splicing is completed. After that, the separator 100 on the second reel can be unwound through the second unwinding shaft 113.

Understandably, in other embodiments, the unwinding mechanism 11 may also include an unwinding frame 111 and an unwinding roller disposed on the unwinding frame 111, where the unwinding roller is configured to unwind the separator 100.

The preheating oven 12 is configured to preheat the separator 100 to flatten the separator 100, which avoids situations such as wrinkling of the separator 100, thus improving the coating quality. The preheating oven 12 is an existing hot air oven, including a preheating oven body 121. Two ends of the preheating oven body 121 are open to allow the separator 100 to enter the preheating oven body 121, and to allow the separator 100 to exit the preheating oven body 121. A plurality of upper conveying rollers 122 and a plurality of lower conveying rollers 123 for conveying the separator 100, and a lower hull are disposed in the preheating oven body 121, and the plurality of upper conveying rollers 122 are located above the plurality of lower conveying rollers 123 and are alternately arranged with the plurality of lower conveying rollers 123 in an upper-lower manner. The plurality of upper conveying rollers 122 and the plurality of lower conveying rollers 123 are configured to convey the separator 100. The number of the upper conveying rollers 122 and the number of the lower conveying rollers 123 can be set according to the actual situation. The lower hull is located below the plurality of lower conveying rollers 123, and a mesh hole communicating with an interior of the lower hull is formed in a top end of the lower hull. Through the mesh hole, hot air can be blown onto the separator 100 to preheat the separator 100. An air inlet is formed in the preheating oven body 121. The air inlet is connected to a hot air blower through a first pipeline and communicates with the interior of the lower hull through a second pipeline. In practical applications, the separator 100 can be conveyed by the plurality of upper conveying rollers 122 and the plurality of lower conveying rollers 123. The hot air generated by the hot air blower can enter the lower hull through the air inlet of the preheating oven body and then be blown out through the mesh hole of the lower hull. In this way, the separator 100 can be preheated. The upper conveying rollers 122 and the lower conveying rollers 123 are of a same type.

Understandably, the preheating oven 12 may also be of other types, such as an infrared oven.

The A-side coating mechanism 13 is configured to coat an A side of the separator 100 to form a first coating of the separator 100. The A side of the separator 100 is, for example, a front side of the separator 100.

The A-side coating mechanism 13 is a micro gravure coating mechanism. The A-side coating mechanism 13 includes a coating frame 131, a gravure roller 132 disposed on the coating frame 131, and two approach rollers 133 disposed on the coating frame 131. The two approach rollers 133 are arranged side by side in an upper-lower manner, the gravure roller 132 is located on one side of the two approach rollers 133, for example, on a left side of the two approach rollers 133, and the gravure roller 132 is opposite to the two approach rollers 133. The two approach rollers 133 are configured to press the separator 100 against the gravure roller 132, and the gravure roller 132 is configured to coat the A side of the separator 100.

Further, the A-side coating mechanism 13 further includes two coating adsorption rollers 134, where the two coating adsorption rollers 134 are both disposed on the coating frame 131, one of the coating adsorption rollers 134 is located below the gravure roller 132 and the two approach rollers 133, and the other coating adsorption roller 134 is located above the gravure roller 132 and the two approach rollers 133. The two coating adsorption rollers 134 are configured to adsorb the separator 100 to cut off a tensile force of the separator 100, which facilitates coating of the A side of the separator 100.

The first oven 14 is configured to heat and dry the first coating of the separator 100.

The B-side coating mechanism 15 is configured to coat a B side of the separator 100 to form a second coating of the separator 100. The B side of the separator 100 is, for example, a back side of the separator 100. The B-side coating mechanism 15 is a micro gravure coating mechanism. The B-side coating mechanism 15 has the same structure as the A-side coating mechanism 13, and also includes a coating frame 131, a gravure roller 132 disposed on the coating frame 131, two approach rollers 133 disposed on the coating frame 131, and two coating adsorption rollers 134 disposed on the coating frame 131, where the gravure roller 132 of the B-side coating mechanism 15 is located on a right side of the two approach rollers 133, and the gravure roller 132 of the B-side coating mechanism 15 is configured to coat the B side of the separator 100. The two coating adsorption rollers 134 of the B-side coating mechanism 15 are configured to adsorb the separator 100 to cut off a tensile force of the separator 100, which facilitates coating of the B side of the separator 100.

The second oven 16 is configured to heat and dry the second coating of the separator 100. In this embodiment, both the first oven 14 and the second oven 16 are existing hot air ovens. Understandably, the first oven 14 and the second oven 16 may also be of other types, such as an infrared oven. The first oven 14 and the second oven 16 each include heating oven bodies 141. As shown in FIG. 4, in this embodiment, there are a plurality of heating oven bodies 141, for example, five. The five heating oven bodies 141 are connected in sequence from left to right. Understandably, the number of the heating oven bodies 141 can be set according to the actual situation. The heating oven bodies 141 of the second oven 16 are disposed at the top end of the support platform 21. Two ends of the heating oven body 141 are open to allow the separator 100 to enter the heating oven body 141, and to allow the separator 100 to exit the heating oven body 141. A plurality of support rollers 142, a hull, and a plurality of air nozzles are disposed in the heating oven body 141. The plurality of support rollers 142 are sequentially arranged at intervals from left to right. The plurality of support rollers 142 are configured to convey the separator 100. The number of the support rollers 142 can be set according to the actual situation. The hull is located above the plurality of support rollers 142. The plurality of air nozzles are arranged at intervals from left to right at a bottom end of the hull. The plurality of air nozzles all communicate with an interior of the hull. The number of the air nozzles can be set according to the actual situation. The plurality of air nozzles of the first oven 14 are configured to blow hot air onto the A side of the separator 100 to heat and dry the first coating of the separator 100. The plurality of air nozzles of the second oven 16 are configured to blow hot air onto the B side of the separator 100 to heat and dry the second coating of the separator 100. An air inlet is formed in the heating oven body 141. The air inlet is connected to a hot air blower through a first pipeline and communicates with the interior of the hull through a second pipeline. In practical applications, the separator 100 can be conveyed by the plurality of support rollers 142. The hot air generated by the hot air blower can enter the hull through the air inlets of the heating oven bodies 141 and then be blown out through the air nozzles. In this way, the coating on the corresponding side of the separator 100 can be heated and dried.

As shown in FIG. 4 and FIG. 7, the discharging traction mechanism 17 is configured to pull the separator 100, the discharging traction mechanism 17 includes a discharging traction platform 171 disposed at the top end of the support platform 21, a plurality of driving traction rollers 172 are disposed on the discharging traction platform 171, the plurality of driving traction rollers 172 are sequentially arranged at intervals from right to left, and the driving traction rollers 172 are configured to pull the separator 100. The number of the driving traction rollers 172 can be set according to the actual situation.

In this embodiment, the discharging traction platform 171 includes a platform body 1711 and a plurality of, for example, two support column groups. The plurality of driving traction rollers 172 above are disposed on the platform body 1711. The two support column groups are arranged side by side in a front-rear manner. Each support column group includes a plurality of, for example, five support columns 1712. The five support columns 1712 are sequentially arranged at intervals from left to right at the top end of the support platform 21, and the platform body 1711 is disposed at top ends of the five support columns 1712 of the two support column groups. Understandably, the number of the support column groups and the number of the support columns 1712 in each support column group can be set according to the actual situation.

The winding traction mechanism 18 is configured to pull the separator 100 to facilitate winding of the separator 100 by the winding mechanism 19. The winding traction mechanism 18 includes a traction frame 181, and a first traction roller 182, a second traction roller 183, and a third traction roller 184 disposed on the traction frame 181. The second traction roller 183 is located above the first traction roller 182, and the third traction roller 184 is located on one side, for example, a left side, between the first traction roller 182 and the second traction roller 183. The first traction roller 182, the second traction roller 183, and the third traction roller 184 are configured to pull the separator 100.

Further, the winding traction mechanism 18 includes a traction adsorption roller 185, where the traction adsorption roller 185 is disposed on the traction frame 181. The traction adsorption roller 185 is located below the first traction roller 182. The traction adsorption roller 185 is configured to adsorb the separator 100 to cut off the tensile force of the separator 100, which facilitates winding of the separator 100 by the winding mechanism 19.

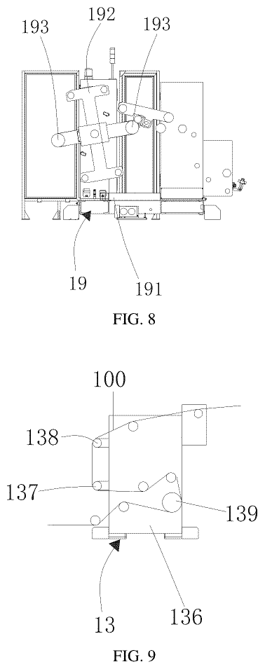

As shown in FIG. 8, the winding mechanism 19 is configured to wind the separator 100. The winding mechanism 19 includes a winding frame 191, a winding turret 192 disposed on the winding frame 191, and two winding shafts 193 disposed on the winding turret 192. The two winding shafts 193 are symmetric about a center of the winding turret 192. The winding turret 192 is configured to drive the two winding shafts 193 to rotate about the center of the winding turret 192 for mutual switching of workstations, so as to achieve roll changing. The winding shafts 193 are configured to wind the separator 100. In practical applications, for the convenience of description, the two winding shafts 193 are named a first winding shaft 193 and a second winding shaft 193 respectively. For example, first, a first reel and a second reel that are empty are mounted on the first winding shaft 193 and the second winding shaft 193 respectively. Then, the separator 100 is wound through the first winding shaft 193, so that the separator 100 is wound around the first reel. When the first reel is nearly full, the first winding shaft 193 and the second winding shaft 193 are driven by the winding turret 192 to rotate about the center of the winding turret 192 for mutual switching of workstations. Next, the moving separator 100 is pressed tightly against an adhesive application position on the second reel and then cut. In this way, tape splicing is completed. After that, the separator 100 can be wound through the second winding shaft 193, so that the separator 100 is wound around the second reel.

Understandably, in other embodiments, the winding mechanism 19 may also include a winding frame 191 and a winding roller disposed on the winding frame 191, where the winding roller is configured to wind the separator 100.

The second coating apparatus 20 has the same structure as the first coating apparatus 10, and also includes an unwinding mechanism 11, a preheating oven 12, an A-side coating mechanism 13, a first oven 14, a B-side coating mechanism 15, a second oven 16, a discharging traction mechanism 17, a winding traction mechanism 18, a winding mechanism 19, and a support platform 21, where the A-side coating mechanism 13 of the second coating apparatus 20 is configured to coat the first coating of the separator 100 to form a third coating of the separator 100, the first oven 14 of the second coating apparatus 20 is configured to heat and dry the third coating of the separator 100, the B-side coating mechanism 15 of the second coating apparatus 20 is configured to coat the second coating of the separator 100 to form a fourth coating of the separator 100, the second oven 16 is configured to heat and dry the fourth coating of the separator 100, and the A-side coating mechanism 13 of the second coating apparatus 20 is a spraying mechanism. As shown in FIG. 9, the A-side coating mechanism 13 of the second coating apparatus 20 includes a spraying frame 136, a spraying machine, and an upper spraying pass roller 138 and a lower spraying pass roller 137 disposed on the spraying frame 136, where the upper spraying pass roller 138 and the lower spraying pass roller 137 are arranged side by side in an upper-lower manner, the spraying machine is disposed on one side of the upper spraying pass roller 138 and the lower spraying pass roller 137, for example, on a left side of the upper spraying pass roller 138 and the lower spraying pass roller 137, and the spraying machine is opposite to the upper spraying pass roller 138 and the lower spraying pass roller 137. The upper spraying pass roller 138 and the lower spraying pass roller 137 are configured to support the separator 100 to form a spraying path. The spraying machine is configured to spray the first coating of the separator 100 to achieve coating of the first coating of the separator 100.

Further, the A-side coating mechanism 13 of the second coating apparatus 20 includes a spraying adsorption roller 139, where the spraying adsorption roller 139 is disposed on the spraying frame 136, and the spraying adsorption roller 139 is located below the lower spraying pass roller 137 and on a right side of the lower spraying pass roller 137. The spraying adsorption roller 139 is configured to adsorb the separator 100 to cut off the tensile force of the separator 100, which facilitates coating of the first coating of the separator 100.

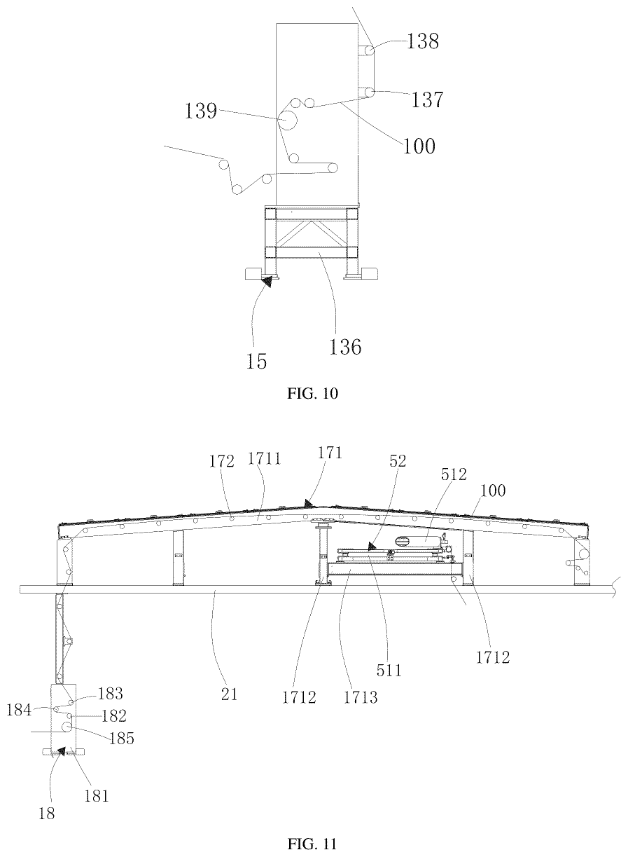

The B-side coating mechanism 15 of the second coating apparatus 20 is also a spraying mechanism. As shown in FIG. 10, the B-side coating mechanism 15 of the second coating apparatus 20 has the same structure as the A-side coating mechanism 13 of the second coating apparatus 20, where a spraying machine of the B-side coating mechanism 15 of the second coating apparatus 20 is disposed on a right side of an upper spraying pass roller 138 and a lower spraying pass roller 137, the spraying machine of the B-side coating mechanism 15 of the second coating apparatus 20 is configured to spray the second coating of the separator 100 to achieve coating of the second coating of the separator 100, a spraying adsorption roller 139 of the B-side coating mechanism 15 of the second coating apparatus 20 is located below the lower spraying pass roller 137 of the B-side coating mechanism 15 of the second coating apparatus 20 and on a left side of the lower spraying pass roller 137, and the spraying adsorption roller 139 of the B-side coating mechanism 15 of the second coating apparatus 20 is configured to adsorb the separator 100 to cut off the tensile force of the separator 100, which facilitates coating of the second coating of the separator 100.

Understandably, in a first alternative solution, both the A-side coating mechanism 13 and the B-side coating mechanism 15 of the second coating apparatus 20 are micro gravure coating mechanisms, and both the A-side coating mechanism 13 and the B-side coating mechanism 15 of the first coating apparatus 10 are spraying mechanisms. In a second alternative solution, the A-side coating mechanism 13 and the B-side coating mechanism 15 of the first coating apparatus 10, and the A-side coating mechanism 13 and the B-side coating mechanism 15 of the second coating apparatus 20 are all micro gravure coating mechanisms. In a third alternative solution, the A-side coating mechanism 13 and the B-side coating mechanism 15 of the first coating apparatus 10, and the A-side coating mechanism 13 and the B-side coating mechanism 15 of the second coating apparatus 20 are all spraying mechanisms. Understandably, the specific types of the A-side coating mechanism 13 and the B-side coating mechanism 15 can be set according to the actual situation.

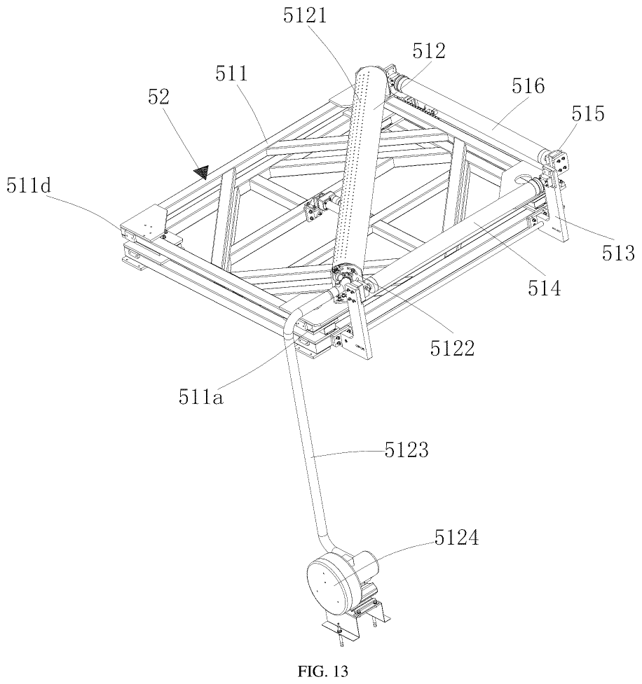

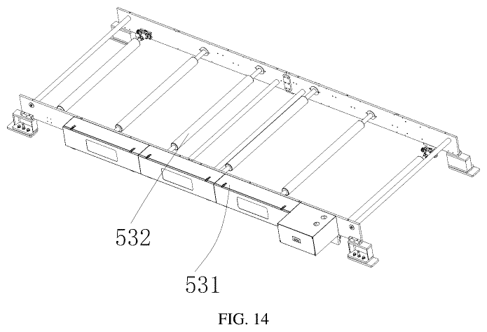

As shown in FIG. 4, FIG. 7, and FIG. 11 to FIG. 14, the reversing apparatus 50 is configured to guide the separator 100 from the first coating apparatus 10 to the second coating apparatus 20. The reversing apparatus 50 includes a first reversing mechanism 51, a second reversing mechanism 52, and a transition mechanism 53.

The first reversing mechanism 51 is disposed in the discharging traction mechanism 17 of the first coating apparatus 10, and the second reversing mechanism 52 is disposed in the discharging traction mechanism 17 of the second coating apparatus 20. The transition mechanism 53 is located between the first reversing mechanism 51 and the second reversing mechanism 52. One end of the transition mechanism 53 is disposed in the discharging traction mechanism 17 of the first coating apparatus 10, and the other end of the transition mechanism 53 is disposed in the discharging traction mechanism 17 of the second coating apparatus 20.

Specifically, the first reversing mechanism 51 and the second reversing mechanism 52 are symmetrically arranged in a front-rear manner. The first reversing mechanism 51 and the second reversing mechanism 52 have the same structure and each include a reversing frame 511 and an air floating roller 512. The reversing frame 511 of the first reversing mechanism 51 is disposed in the discharging traction platform 171 of the first coating apparatus 10, and the reversing frame 511 of the second reversing mechanism 52 is disposed in the discharging traction platform 171 of the second coating apparatus 20. The reversing frame 511 has a square structure. The reversing frame 511 has a first corner 511a and a second corner arranged diagonally, and a third corner and a fourth corner 511d arranged diagonally. The first corner 511a and the third corner are close to the transition mechanism 53, and the third corner is located between the first corner 511a and the second oven 16. The air floating roller 512 has a hollow structure. A length direction of the air floating roller 512 intersects with a center line of the reversing frame 511 in a length direction. One end of the air floating roller 512 is close to the first corner 511a and located between the first corner 511a and the third corner, and the other end of the air floating roller 512 is close to the second corner and located between the fourth corner 511d and the second corner. Two sealing plates 5122 are disposed at one end and the other end of the air floating roller 512 respectively. The two sealing plates 5122 are disposed at a top end of the reversing frame 511. One of the sealing plates 5122, for example, the sealing plate 5122 close to the first corner of the reversing frame 511, is provided with a connector. The connector communicates with an interior of the air floating roller 512 and is connected to an air blower 5124 through a connecting tube 5123, where the air blower 5124 of the first reversing mechanism 51 is disposed at the top end of the support platform 21 of the first coating apparatus 10, and the air blower 5124 of the second reversing mechanism 52 is disposed at the top end of the support platform 21 of the second coating apparatus 20. An outer peripheral surface of the air floating roller 512 is provided with an air hole area. The air hole area faces the fourth corner 511d of the reversing frame 511, and a plurality of air outlet holes 5121 are evenly distributed in the air hole area. The plurality of air outlet holes 5121 all communicate with the interior of the air floating roller 512. The number and size of the air outlet holes 5121 can be set according to the actual situation. The air floating roller 512 is configured to provide suspended support for the separator 100 to avoid direct contact with the separator 100, thus preventing damage to the separator 100, and ensuring the coating quality. The reversing frame 511 plays a role in mounting and supporting the air floating roller 512. In practical applications, when the separator 100 passes through the air hole area of the air floating roller 512, the air blower 5124 can blow air into the interior of the air floating roller 512 through the connecting tube 5123 and the connector, and then the air flows out from the plurality of air outlet holes 5121. The air flowing out from the plurality of air outlet holes 5121 can form a highly rigid and uniform air film on the outer peripheral surface of the air floating roller 512. Through the air film, the separator 100 can be lifted up, so that the separator 100 is suspended, thus achieving suspended support for the separator 100.

In this embodiment, as shown in FIG. 7 and FIG. 11, a base 1713 is disposed in the discharging traction platform 171, the base 1713 is located below the platform body 1711, one end of the base 1713 is connected to two of the front support columns 1712 of the discharging traction platform 171, and the other end of the base 1713 is connected to two of the rear support columns 1712 of the discharging traction platform 171. The reversing frame 511 is disposed at a top end of the base 1713.

The transition mechanism 53 is configured to support the separator 100. The transition mechanism 53 includes a transition platform 531, where one end of the transition platform 531 is disposed in the discharging traction platform 171 of the first coating apparatus 10, and the other end of the transition platform 531 is disposed in the discharging traction platform 171 of the second coating apparatus 20. In this embodiment, the transition platform 531 is located between the base 1713 in the discharging traction platform 171 of the first coating apparatus 10 and the base 1713 in the discharging traction platform 171 of the second coating apparatus 20, and two ends of the transition platform 531 are connected to the base 1713 in the discharging traction platform 171 of the first coating apparatus 10 and the base 1713 in the discharging traction platform 171 of the second coating apparatus 20 respectively. The transition platform 531 is located between the reversing frame 511 of the first reversing mechanism 51 and the reversing frame 511 of the second reversing mechanism 52, and is located below the reversing frame 511 of the first reversing mechanism 51 and the reversing frame 511 of the second reversing mechanism 52. A plurality of transition pass rollers 532 are disposed on the transition platform 531. The plurality of transition pass rollers 532 are sequentially arranged at intervals from front to rear. The transition pass rollers 532 are configured to support the separator 100. The number of the transition pass rollers 532 can be set according to the actual situation.

Further, a flattening frame 513 is disposed on one side of the reversing frame 511 close to the transition platform 531, the flattening frame 513 is located above the transition platform 531, and a flattening roller 514 is disposed on the flattening frame 513. The flattening roller 514 is configured to flatten the separator 100 to avoid situations such as wrinkling of the separator 100, thus improving the coating quality.

Further, a pass roller frame 515 is disposed on one side of the reversing frame 511 close to the second oven 16, and a reversing pass roller 516 is disposed on the pass roller frame 515. The reversing pass roller 516 is configured to support the separator 100. In this embodiment, there are two reversing pass rollers 516 in the first reversing mechanism 51, the two reversing pass rollers 516 are arranged side by side in an upper-lower manner, and there is one reversing pass roller 516 in the second reversing mechanism 52. Understandably, the number of the reversing pass rollers 516 can be set according to the actual situation.

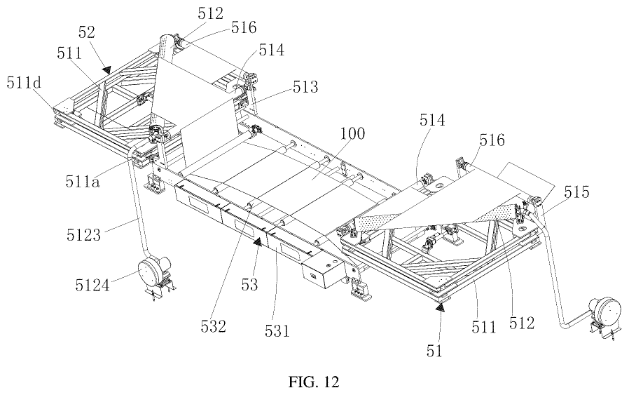

According to the present application, with the above structure, when the separator 100 is actually coated for four times, except that the winding mechanism 19 and the winding traction mechanism 18 of the first coating apparatus 10, and the unwinding mechanism 11 and the preheating oven 12 of the second coating apparatus 20 are not activated, the remaining mechanisms of the first coating apparatus 10, the remaining mechanisms of the second coating apparatus 20, and the reversing apparatus 50 are all activated. As shown in FIG. 4, first, the separator 100 is unwound by the unwinding mechanism 11 of the first coating apparatus 10. The unwound separator 100 first enters the preheating oven body 121 of the preheating oven 12 of the first coating apparatus 10 and passes over the plurality of upper conveying rollers 122 and the plurality of lower conveying rollers 123, so that the separator 100 is conveyed by the plurality of upper conveying rollers 122 and the plurality of lower conveying rollers 123. The separator 100 can be preheated through the hot air blown out from the mesh hole of the lower hull of the preheating oven 12 of the first coating apparatus 10. Then, the separator 100 comes out from the preheating oven body 121 of the preheating oven 12 of the first coating apparatus 10, and sequentially passes over the lower coating adsorption roller 134 of the A-side coating mechanism 13 of the first coating apparatus 10, between the gravure roller 132 and the two approach rollers 133, and over the upper coating adsorption roller 134. The separator 100 can be pressed against the gravure roller 132 of the A-side coating mechanism 13 of the first coating apparatus 10 by the two approach rollers 133 of the A-side coating mechanism 13 of the first coating apparatus 10, so that the A side of the separator 100 is coated by the gravure roller 132 to form the first coating of the separator 100. Then, the separator 100 enters the heating oven body 141 of the first oven 14 of the first coating apparatus 10 and passes over the plurality of support rollers 142, so that the separator 100 is conveyed by the plurality of support rollers 142. The first coating of the separator 100 can be heated and dried through the air nozzles of the first oven 14 of the first coating apparatus 10. Then, the separator 100 comes out from the heating oven body 141 of the first oven 14 of the first coating apparatus 10, and sequentially passes over the lower coating adsorption roller 134 of the B-side coating mechanism 15 of the first coating apparatus 10, between the gravure roller 132 and the two approach rollers 133, and over the upper coating adsorption roller 134. The separator 100 can be pressed against the gravure roller 132 of the B-side coating mechanism 15 of the first coating apparatus 10 by the two approach rollers 133 of the B-side coating mechanism 15 of the first coating apparatus 10, so that the B side of the separator 100 is coated by the gravure roller 132 to form the second coating of the separator 100. Then, the separator 100 enters the heating oven body 141 of the second oven 16 of the first coating apparatus 10 and passes over the plurality of support rollers 142, so that the separator 100 is conveyed by the plurality of support rollers 142. The second coating of the separator 100 can be heated and dried through the air nozzles of the second oven 16 of the first coating apparatus 10. Then, the separator 100 comes out from the heating oven body 141 of the second oven 16 of the first coating apparatus 10 and passes over some of the driving traction rollers 172 of the discharging traction mechanism 17 of the first coating apparatus 10. Then, the separator 100 sequentially passes over the reversing roller 516 of the first reversing mechanism 51, through the air hole area of the air floating roller 512 of the first reversing mechanism 51, and over the flattening roller 514 of the first reversing mechanism 51. As shown in FIG. 12, the separator 100 passes over the plurality of transition pass rollers 532 of the transition mechanism 53, over the flattening roller 514 of the second reversing mechanism 52, through the air hole area of the air floating roller 512 of the second reversing mechanism 52, and over the reversing roller 516 of the second reversing mechanism 52. Then, the separator 100 sequentially passes over the spraying adsorption roller 139 of the A-side coating mechanism 13 of the second coating apparatus 20, over the lower spraying pass roller 137, and over the upper spraying pass roller 138. The first coating of the separator 100 can be coated by the spraying machine of the A-side coating mechanism 13 of the second coating apparatus 20 to form the third coating of the separator 100. Then, the separator 100 enters the heating oven body 141 of the first oven 14 of the second coating apparatus 20 and passes over the plurality of support rollers 142, so that the separator 100 is conveyed by the plurality of support rollers 142. The third coating of the separator 100 can be heated and dried through the air nozzles of the first oven 14 of the second coating apparatus 20. Then, the separator 100 comes out from the heating oven body 141 of the first oven 14 of the second coating apparatus 20, and sequentially passes over the spraying adsorption roller 139 of the B-side coating mechanism 15 of the second coating apparatus 20, over the lower spraying pass roller 137, and over the upper spraying pass roller 138. The second coating of the separator 100 can be coated by the spraying machine of the B-side coating mechanism 15 of the second coating apparatus 20 to form the fourth coating of the separator 100. Then, the separator 100 enters the heating oven body 141 of the second oven 16 of the second coating apparatus 20 and passes over the plurality of support rollers 142, so that the separator 100 is conveyed by the plurality of support rollers 142. The fourth coating of the separator 100 can be heated and dried through the air nozzles of the second oven 16 of the second coating apparatus 20. Then, the separator 100 comes out from the heating oven body 141 of the second oven 16 of the second coating apparatus 20, and passes over the plurality of driving traction rollers 172 of the discharging traction mechanism 17 of the second coating apparatus 20, and over the second traction roller 183, the third traction roller 184, the first traction roller 182, and the traction adsorption roller 185 of the winding traction mechanism 18 of the second coating apparatus 20. Then, the separator 100 is wound by the winding mechanism 19 of the second coating apparatus 20.

In addition, according to the present application, with the above structure, single coating, double coating, and triple coating on the separator can be achieved.

When the separator 100 is actually coated once, for example, the first coating apparatus 10 and the reversing apparatus 50 are not activated, and except that the spraying machine of the B-side coating mechanism 15 and the hot air blower of the second oven 16 are not activated, all other mechanisms of the second coating apparatus 20 are activated. At this time, the B-side coating mechanism 15 and the second oven 16 of the second coating apparatus 20 only play a role in conveying the separator 100: First, the separator 100 is unwound by the unwinding mechanism 11 of the second coating apparatus 20. The unwound separator 100 first enters the preheating oven body 121 of the preheating oven 12 of the second coating apparatus 20 and passes over the plurality of upper conveying rollers 122 and the plurality of lower conveying rollers 123, so that the separator 100 is conveyed by the plurality of upper conveying rollers 122 and the plurality of lower conveying rollers 123. The separator 100 can be preheated through the hot air blown out from the mesh hole of the lower hull of the preheating oven 12 of the second coating apparatus 20. Then, the separator 100 comes out from the preheating oven body 121 of the preheating oven 12 of the second coating apparatus 20, and sequentially passes over the spraying adsorption roller 139 of the A-side coating mechanism 13 of the second coating apparatus 20, over the lower spraying pass roller 137, and over the upper spraying pass roller 138. The A side of the separator 100 can be coated by the spraying machine of the A-side coating mechanism 13 of the second coating apparatus 20 to form the coating of the separator 100. Then, the separator 100 enters the heating oven body 141 of the first oven 14 of the second coating apparatus 20 and passes over the plurality of support rollers 142, so that the separator 100 is conveyed by the plurality of support rollers 142. The coating of the separator 100 can be heated and dried through the air nozzles of the first oven 14 of the second coating apparatus 20. Then, the separator 100 sequentially passes over the spraying adsorption roller 139 of the B-side coating mechanism 15 of the second coating apparatus 20, over the lower spraying pass roller 137, and over the upper spraying pass roller 138. Then, the separator 100 enters the heating oven body 141 of the second oven 16 of the second coating apparatus 20 and passes over the plurality of support rollers 142, so that the separator 100 is conveyed by the plurality of support rollers 142. Then, the separator 100 comes out from the heating oven body 141 of the second oven 16 of the second coating apparatus 20 and passes over the plurality of the driving traction rollers 172 of the discharging traction mechanism 17. Then, the separator 100 passes over the second traction roller 183, the third traction roller 184, the first traction roller 182, and the traction adsorption roller 185 of the winding traction mechanism 18 of the second coating apparatus 20. Then, the separator 100 is wound by the winding mechanism 19 of the second coating apparatus 20.

Understandably, there may also be another way to conduct single coating on the separator 100. That is, the second coating apparatus 20 and the reversing apparatus 50 are not activated, and except that the gravure roller 132 of the B-side coating mechanism 15 and the hot air blower of the second oven 16 are not activated, all other mechanisms of the first coating apparatus 10 are activated. At this time, the B-side coating mechanism 15 and the second oven 16 of the first coating apparatus 10 only play a role in conveying the separator 100. A moving path of the separator 100 is as follows: the unwinding mechanism 11 of the first coating apparatus 10, the preheating oven 12 of the first coating apparatus 10, the A-side coating mechanism 13 of the first coating apparatus 10, the first oven 14 of the first coating apparatus 10, the B-side coating mechanism 15 of the first coating apparatus 10, the second oven 16 of the first coating apparatus 10, the discharging traction mechanism 17 of the first coating apparatus 10, the winding traction mechanism 18 of the first coating apparatus 10, and the winding mechanism 19 of the first coating apparatus 10. By these mechanisms, single coating on the separator 100 can be achieved.

When the separator 100 is actually coated twice, for example, the first coating apparatus 10 and the reversing apparatus 50 are not activated, and the second coating apparatus 20 is activated: First, the separator 100 is unwound by the unwinding mechanism 11 of the second coating apparatus 20. The unwound separator 100 first enters the preheating oven body 121 of the preheating oven 12 of the second coating apparatus 20 and passes over the plurality of upper conveying rollers 122 and the plurality of lower conveying rollers 123, so that the separator 100 is conveyed by the plurality of upper conveying rollers 122 and the plurality of lower conveying rollers 123. The separator 100 can be preheated through the hot air blown out from the mesh hole of the lower hull of the preheating oven 12 of the second coating apparatus 20. Then, the separator 100 comes out from the heating oven body 121 of the preheating oven 12 of the second coating apparatus 20, and sequentially passes over the spraying adsorption roller 139 of the A-side coating mechanism 13 of the second coating apparatus 20, over the lower spraying pass roller 137, and over the upper spraying pass roller 138. The A side of the separator 100 can be coated by the spraying machine of the A-side coating mechanism 13 of the second coating apparatus 20 to form the first coating of the separator 100. Then, the separator 100 enters the heating oven body 141 of the first oven 14 of the second coating apparatus 20 and passes over the plurality of support rollers 142, so that the separator 100 is conveyed by the plurality of support rollers 142. The first coating of the separator 100 can be heated and dried through the air nozzles of the first oven 14 of the second coating apparatus 20. Then, the separator 100 comes out from the heating oven body 141 of the first oven 14 of the second coating apparatus 20, and sequentially passes over the spraying adsorption roller 139 of the B-side coating mechanism 15 of the second coating apparatus 20, over the lower spraying pass roller 137, and over the upper spraying pass roller 138. The B side of the separator 100 can be coated by the spraying machine of the B-side coating mechanism 15 of the second coating apparatus 20 to form the second coating of the separator 100. Then, the separator 100 enters the heating oven body 141 of the second oven 16 of the second coating apparatus 20 and passes over the plurality of support rollers 142, so that the separator 100 is conveyed by the plurality of support rollers 142. The second coating of the separator 100 can be heated and dried through the air nozzles of the second oven 16 of the second coating apparatus 20. Then, the separator 100 comes out from the heating oven body 141 of the second oven 16 of the second coating apparatus 20 and passes over the plurality of the driving traction rollers 172 of the discharging traction mechanism 17 of the second coating apparatus 20. Then, the separator 100 passes over the second traction roller 183, the third traction roller 184, the first traction roller 182, and the traction adsorption roller 185 of the winding traction mechanism 18 of the second coating apparatus 20. Then, the separator 100 is wound by the winding mechanism 19 of the second coating apparatus 20.

Understandably, there may also be another way to conduct double coating on the separator 100. That is, the second coating apparatus 20 and the reversing apparatus 50 are not activated, and the first coating apparatus 10 is activated. At this time, a moving path of the separator is as follows: the unwinding mechanism 11 of the first coating apparatus 10, the preheating oven 12 of the first coating apparatus 10, the A-side coating mechanism 13 of the first coating apparatus 10, the first oven 14 of the first coating apparatus 10, the B-side coating mechanism 15 of the first coating apparatus 10, the second oven 16 of the first coating apparatus 10, the discharging traction mechanism 17 of the first coating apparatus 10, the winding traction mechanism 18 of the first coating apparatus 10, and the winding mechanism 19 of the first coating apparatus 10. By these mechanisms, double coating on the separator 100 can be achieved.

When the separator 100 is actually coated for three times, except that the winding mechanism 19 and the winding traction mechanism 18 of the first coating apparatus 10 and the unwinding mechanism 11, the preheating oven 12, the spraying machine of the B-side coating mechanism 15, and the hot air blower of the second oven 16 of the second coating apparatus 20 are not activated, all other mechanisms are activated. At this time, the B-side coating mechanism 15 and the second oven 16 of the second coating apparatus 20 only play a role in conveying the separator 100: First, the separator 100 is unwound by the unwinding mechanism 11 of the first coating apparatus 10. The unwound separator 100 first enters the preheating oven body 121 of the preheating oven 12 of the first coating apparatus 10 and passes over the plurality of upper conveying rollers 122 and the plurality of lower conveying rollers 123, so that the separator 100 is conveyed by the plurality of upper conveying rollers 122 and the plurality of lower conveying rollers 123. The separator 100 can be preheated through the hot air blown out from the mesh hole of the lower hull of the preheating oven 12 of the first coating apparatus 10. Then, the separator 100 comes out from the preheating oven body 121 of the preheating oven 12 of the first coating apparatus 10, and sequentially passes over the lower coating adsorption roller 134 of the A-side coating mechanism 13 of the first coating apparatus 10, between the gravure roller 132 and the two approach rollers 133, and over the upper coating adsorption roller 134. The separator 100 can be pressed against the gravure roller 132 of the A-side coating mechanism 13 of the first coating apparatus 10 by the two approach rollers 133 of the A-side coating mechanism 13 of the first coating apparatus 10, so that the A side of the separator 100 is coated by the gravure roller 132 to form the first coating of the separator 100. Then, the separator 100 enters the heating oven body 141 of the first oven 14 of the first coating apparatus 10 and passes over the plurality of support rollers 142, so that the separator 100 is conveyed by the plurality of support rollers 142. The first coating of the separator 100 can be heated and dried through the air nozzles of the first oven 14 of the first coating apparatus 10. Then, the separator 100 comes out from the heating oven body 141 of the first oven 14 of the first coating apparatus 10, and sequentially passes over the lower coating adsorption roller 134 of the B-side coating mechanism 15 of the first coating apparatus 10, between the gravure roller 132 and the two approach rollers 133, and over the upper coating adsorption roller 134. The separator 100 can be pressed against the gravure roller 132 of the B-side coating mechanism 15 of the first coating apparatus 10 by the two approach rollers 133 of the B-side coating mechanism 15 of the first coating apparatus 10, so that the B side of the separator 100 is coated by the gravure roller 132 to form the second coating of the separator 100. Then, the separator 100 enters the heating oven body 141 of the second oven 16 of the first coating apparatus 10 and passes over the plurality of support rollers 142, so that the separator 100 is conveyed by the plurality of support rollers 142. The second coating of the separator 100 can be heated and dried through the air nozzles of the second oven 16 of the first coating apparatus 10. Then, the separator 100 comes out from the heating oven body 141 of the second oven 16 of the first coating apparatus 10 and passes over some of the driving traction rollers 172 of the discharging traction mechanism 17 of the first coating apparatus 10. Then, the separator 100 passes over the reversing roller 516 of the first reversing mechanism 51, through the air hole area of the air floating roller 512 of the first reversing mechanism 51, and over the flattening roller 514 of the first reversing mechanism 51. As shown in FIG. 12, the separator 100 passes over the plurality of transition pass rollers 532 of the transition mechanism 53, over the flattening roller 514 of the second reversing mechanism 52, through the air hole area of the air floating roller 512 of the second reversing mechanism 52, and over the reversing roller 516 of the second reversing mechanism 52. Then, the separator 100 sequentially passes over the spraying adsorption roller 139 of the A-side coating mechanism 13 of the second coating apparatus 20, over the lower spraying pass roller 137, and over the upper spraying pass roller 138. The first coating of the separator 100 can be coated by the spraying machine of the A-side coating mechanism 13 of the second coating apparatus 20 to form the third coating of the separator 100. Then, the separator 100 enters the heating oven body 141 of the first oven 14 of the second coating apparatus 20 and passes over the plurality of support rollers 142, so that the separator 100 is conveyed by the plurality of support rollers 142. The third coating of the separator 100 can be heated and dried through the air nozzles of the first oven 14 of the second coating apparatus 20. Then, the separator 100 comes out from the heating oven body 141 of the first oven 14 of the second coating apparatus 20, and sequentially passes over the spraying adsorption roller 139 of the B-side coating mechanism 15 of the second coating apparatus 20, over the lower spraying pass roller 137, and over the upper spraying pass roller 138. Then, the separator 100 enters the heating oven body 141 of the second oven 16 of the second coating apparatus 20 and passes over the plurality of support rollers 142, so that the separator 100 is conveyed by the plurality of support rollers 142. Then, the separator 100 comes out from the heating oven body 141 of the second oven 16 of the second coating apparatus 20, and passes over the plurality of driving traction rollers 172 of the discharging traction mechanism 17 of the second coating apparatus 20, and over the second traction roller 183, the third traction roller 184, the first traction roller 182, and the traction adsorption roller 185 of the winding traction mechanism 18 of the second coating apparatus 20. Then, the separator 100 is wound by the winding mechanism 19 of the second coating apparatus 20.

According to the present application, the first coating apparatus 10, the second coating apparatus 20, and the reversing apparatus 50 are disposed, where the first coating apparatus 10 and the second coating apparatus 20 each include the unwinding mechanism 11, the A-side coating mechanism 13, the first oven 14, the B-side coating mechanism 15, the second oven 16, the discharging traction mechanism 17, and the winding mechanism 19, and the reversing apparatus 50 includes the first reversing mechanism 51, the second reversing mechanism 52, and the transition mechanism 53. The A side and the B side of the separator 100 can be coated by the first coating apparatus 10 to form the first coating and the second coating of the separator 100. The separator 100 can be guided from the first coating apparatus 10 to the second coating apparatus 20 by the reversing apparatus 50, so that the first coating of the separator 100 and the second coating of the separator 100 can be coated by the second coating apparatus 20 to form the third coating and the fourth coating of the separator 100. In this way, the separator 100 can be coated for four times. Compared with the prior art, the number of production personnel and material transfer procedures can be reduced, the production efficiency is greatly improved, and the production cost is lowered. In addition, according to the present application, single coating, double coating, and triple coating on the separator 100 can be achieved; and the device has multiple functions, can adopt different coating methods, has a high utilization rate, and greatly satisfies the production requirements.

The above is a specific description of preferred embodiments of the present application, but the present application is not limited to the embodiments. Those skilled in the art may also make various equivalent modifications or substitutions without departing from the spirit of the present application, and these equivalent modifications or substitutions are all included within the scope of the claims of the present application.

What is claimed is:

1. A separator parallel coating device, comprising a first coating apparatus, a second coating apparatus, and a reversing apparatus, wherein
the first coating apparatus and the second coating apparatus are arranged side by side in a front-rear manner,
the first coating apparatus and the second coating apparatus each comprise an unwinding mechanism, an A-side coating mechanism, a first oven, a B-side coating mechanism, a second oven, a discharging traction mechanism, and a winding mechanism, the winding mechanism, the unwinding mechanism, the A-side coating mechanism, the first oven, and the B-side coating mechanism are sequentially arranged at intervals from left to right,
the discharging traction mechanism is located above the unwinding mechanism and the A-side coating mechanism, the second oven is located above the first oven,
the reversing apparatus comprises a first reversing mechanism, a second reversing mechanism, and a transition mechanism, the first reversing mechanism is disposed in the discharging traction mechanism of the first coating apparatus, the second reversing mechanism is disposed in the discharging traction mechanism of the second coating apparatus, and
the transition mechanism is located between the first reversing mechanism and the second reversing mechanism, and the transition mechanism has one end disposed in the discharging traction mechanism of the first coating apparatus, and the other end disposed in the discharging traction mechanism of the second coating apparatus.

2. The separator parallel coating device according to claim 1, wherein the first coating apparatus and the second coating apparatus each comprise a support platform, the unwinding mechanism, the A-side coating mechanism, the first oven, and the B-side coating mechanism are all located in the support platform, both the discharging traction mechanism and the second oven are disposed at a top end of the support platform, the discharging traction mechanism comprises a discharging traction platform disposed at the top end of the support platform, a plurality of driving traction rollers are disposed on the discharging traction platform, and the plurality of driving traction rollers are sequentially arranged at intervals from right to left.

3. The separator parallel coating device according to claim 2, wherein the first reversing mechanism and the second reversing mechanism are symmetrically arranged in a front-rear manner, the first reversing mechanism and the second reversing mechanism each comprise a reversing frame and an air floating roller,
the reversing frame of the first reversing mechanism is disposed in the discharging traction platform of the first coating apparatus, the reversing frame of the second reversing mechanism is disposed in the discharging traction platform of the second coating apparatus, and
the air floating roller has a hollow structure, two sealing plates are disposed at one end and the other end of the air floating roller respectively, the two sealing plates are disposed at a top end of the reversing frame, one of the sealing plates is provided with a connector, the connector communicates with an interior of the air floating roller and is connected to an air blower, an outer peripheral surface of the air floating roller is provided with an air hole area where a plurality of air outlet holes are evenly distributed, and the plurality of air outlet holes all communicate with the interior of the air floating roller.

4. The separator parallel coating device according to claim 3, wherein the reversing frame has a first corner and a second corner arranged diagonally, and a third corner and a fourth corner arranged diagonally, both the first corner and the third corner are close to the transition mechanism, the third corner is located between the first corner and the second oven, the air floating roller has one end close to the first corner and located between the first corner and the third corner, and the other end close to the second corner and located between the fourth corner and the second corner, and the air hole area faces the fourth corner of the reversing frame.

5. The separator parallel coating device according to claim 3, wherein the transition mechanism comprises a transition platform, the transition platform has one end disposed in the discharging traction platform of the first coating apparatus, and the other end disposed in the discharging traction platform of the second coating apparatus, the transition platform is located between and below the reversing frame of the first reversing mechanism and the reversing frame of the second reversing mechanism, a plurality of transition pass rollers are disposed on the transition platform, and the plurality of transition pass rollers are sequentially arranged at intervals from front to rear.

6. The separator parallel coating device according to claim 5, wherein a flattening frame is disposed on one side of the reversing frame close to the transition platform, the flattening frame is located above the transition platform, and a flattening roller is disposed on the flattening frame.

7. The separator parallel coating device according to claim 3, wherein a pass roller frame is disposed on one side of the reversing frame close to the second oven, and a reversing pass roller is disposed on the pass roller frame.

8. The separator parallel coating device according to claim 1, wherein the A-side coating mechanism and the B-side coating mechanism of the first coating apparatus each comprise a coating frame, and a gravure roller and two approach rollers disposed on the coating frame, the two approach rollers are arranged side by side in an upper-lower manner, and the gravure roller is located on one side of the two approach rollers and is opposite to the two approach rollers.

9. The separator parallel coating device according to claim 1, wherein the A-side coating mechanism and the B-side coating mechanism of the second coating apparatus each comprise a spraying frame, a spraying machine, and an upper spraying pass roller and a lower spraying pass roller disposed on the spraying frame, the upper spraying pass roller and the lower spraying pass roller are arranged side by side in an upper-lower manner, and the spraying machine is disposed on one side of the upper spraying pass roller and the lower spraying pass roller, and is opposite to the upper spraying pass roller and the lower spraying pass roller.

10. The separator parallel coating device according to claim 2, wherein the first coating apparatus and the second coating apparatus each comprise a preheating oven disposed between the unwinding mechanism and the A-side coating mechanism, and a winding traction mechanism disposed between the winding mechanism and the unwinding mechanism, and both the preheating oven and the winding traction mechanism are located below the discharging traction mechanism and in the support platform.
